(19) United States
(12) Patent Application Publication
(10) Pub. No.: US 2006/0101966 A1
(43) Pub. Date: May 18, 2006

(54) Alignment system coupling apparatus and method

(76) Inventors: Jaime E. Garcia, Jackson, TN (US); Jeffrey D. Weston, Jackson, TN (US)

Correspondence Address: THE BLACK & DECKER CORPORATION, 701 EAST JOPPA ROAD, TW199, TOWSON, MD, 21286, US

(21) Appl. No.: 11/124,363

(22) Filed: May 6, 2005

Related U.S. Application Data
(60) Provisional application No. 60/568,808, filed on May 6, 2004.

(51) Int. Cl. B23D 45/06

(52) U.S. Cl. 83/438; 83/477.2

(57) ABSTRACT

An alignment apparatus includes first and second wedging members, each having individually corresponding inclined surfaces, and further includes first and second rail sections, each having a surface defining at least one aperture configured for receiving a fastener. The first and second wedging members are positionable so that at least a portion of each wedging member is within both the first rail section and the second rail section. The first and second wedging members are further positionable so that their corresponding inclined surfaces are forcibly engaged via fasteners introduced through each aperture, the first and second wedging members further engaging with at least a portion of the first and second rail sections so as to connect the rail sections.

### CROSS-REFERENCE TO RELATED APPLICATIONS

The present application claims priority under 35 U.S.C. § 119(e) to U.S. Provisional Application No. 60/568,808 entitled: Alignment System Coupling Apparatus and Method filed May 6, 2004, which is hereby incorporated by reference in its entirety.

### FIELD OF THE INVENTION

The present invention generally relates to the field of power machinery, and particularly to an alignment apparatus, such as a rail for an alignment fence of a table saw, and a method for coupling an alignment apparatus.

### BACKGROUND OF THE INVENTION

Power machinery is often equipped with an alignment system. For example, a table saw generally includes an alignment fence mounted via a rail, the rail extending substantially perpendicular to the working tool. The alignment fence may be slidably positioned along the rail for ensuring precise, repeatable workpiece positioning relative to the working tool. When positioning larger workpieces, it may be necessary for an alignment fence to travel a longer path to accommodate such workpieces. This requires a longer rail. In the case of table saws, some models may have rails that are approximately six feet in length. Transporting a rail of such length can be expensive and problematic, primarily because the rail may need to be packaged in an elongated box and thus, may be more easily damaged. Extensive assembly of the rail is not desirable because it may detract from the consumer's “out of box” experience, or first impression of the rail when he or she first opens the box in which it was packaged. If this “out of box” experience is negative, the consumer may have an overall bad impression. Therefore, it would be advantageous to have an alignment apparatus, such as a rail for an alignment fence of a table saw, and a method for coupling an alignment apparatus, which allow for packaging of the rail in sections, so as to minimize risk of damage to the rail during transport. Further it would be advantageous to have an alignment apparatus, such as a rail for an alignment fence of a table saw and method for coupling an alignment apparatus, which allow for the rail sections to be coupled by a consumer without extensive assembly.

### SUMMARY OF THE INVENTION

Accordingly, an aspect of the present invention is directed to an alignment apparatus, including a first wedging member, a second wedging member, a first rail section and a second rail section. The first and second wedging members each have individually corresponding inclined surfaces. The first and second rail sections are each configured with one or more apertures for receiving a fastener. The first and second wedging members are positionable so that at least a portion of each wedging member is within both the first rail section and the second rail section. The first and second wedging members are further positionable so that the corresponding inclined surfaces of the first and second wedging members are forcibly engageable via fasteners introduced through each aperture. The first and second wedging members are further engageable with at least a portion of the first and second rail sections so as to connect the rail sections.

An additional aspect of the present invention is directed to a method for coupling an alignment apparatus, such as a rail for an alignment fence of a table saw. The method includes the step of positioning a first wedging member at least partially within both a first rail section and a second rail section, the first and second rail sections being oriented in an end to end configuration. The method further includes the step of positioning a second wedging member at least partially within both the first rail section and the second rail section. The method further includes the step of forcibly engaging the wedging members, via fasteners introduced through the rail sections, thereby connecting the rail sections.

It is to be understood that both the forgoing general description and the following detailed description are exemplary and explanatory only and are not necessarily restrictive of the invention as claimed. The accompanying drawings, which are incorporated in and constitute a part of the specification, illustrate an embodiment of the invention and together with the general description, serve to explain the principles of the invention.

### BRIEF DESCRIPTION OF THE DRAWINGS

The numerous advantages of the present invention may be better understood by those skilled in the art by reference to the accompanying figures in which:

FIG. 1 is a perspective view of a table saw including an alignment fence and a rail;

FIG. 2 is an enlarged view of the alignment system of a table saw, including an alignment fence and a rail in accordance with an embodiment of the present invention;

FIG. 3 is a cross-sectional view of connected rail sections of a table saw in accordance with an embodiment of the present invention;

FIG. 4 is an exploded view of rail sections of a table saw in accordance with an embodiment of the present invention;

FIG. 5 is a flowchart illustrating a method for coupling an alignment apparatus in accordance with an embodiment of the present invention; and

FIG. 6 is a flowchart illustrating a method for coupling an alignment apparatus in accordance with an embodiment of the present invention.

### DETAILED DESCRIPTION OF THE INVENTION

Reference will now be made in detail to the presently preferred embodiments of the invention, examples of which are illustrated in the accompanying drawings.

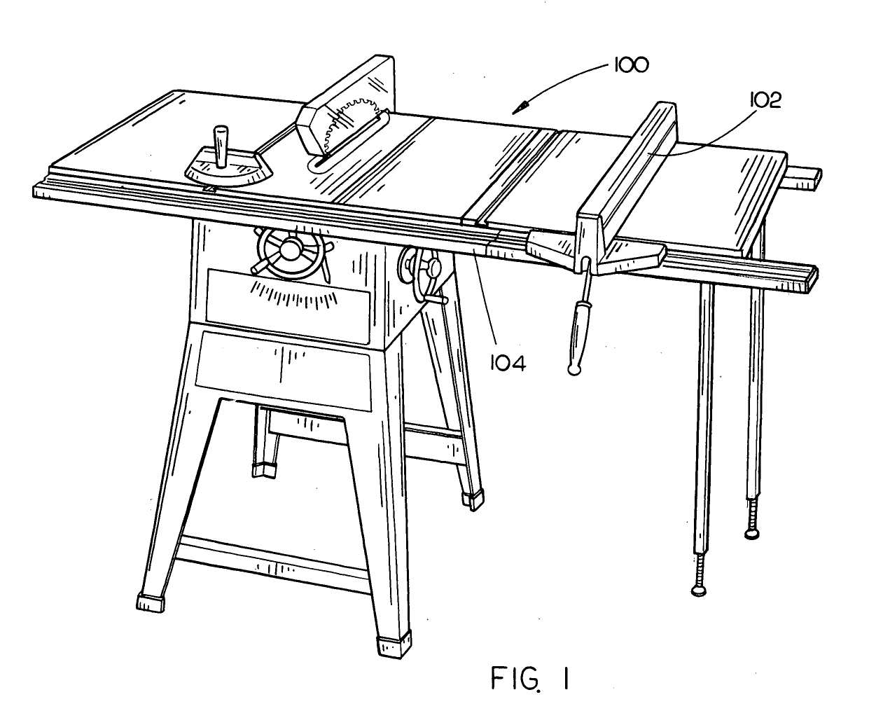

Referring to FIG. 1, a table saw 100, having an alignment system, which includes an alignment fence 102 and a rail 104 is described. The alignment fence 102 is slidably mounted to the support surface of the table saw 100 via the rail 104, which extends substantially perpendicular to the saw blade, so that the fence 102 is aligned parallel with the saw blade.

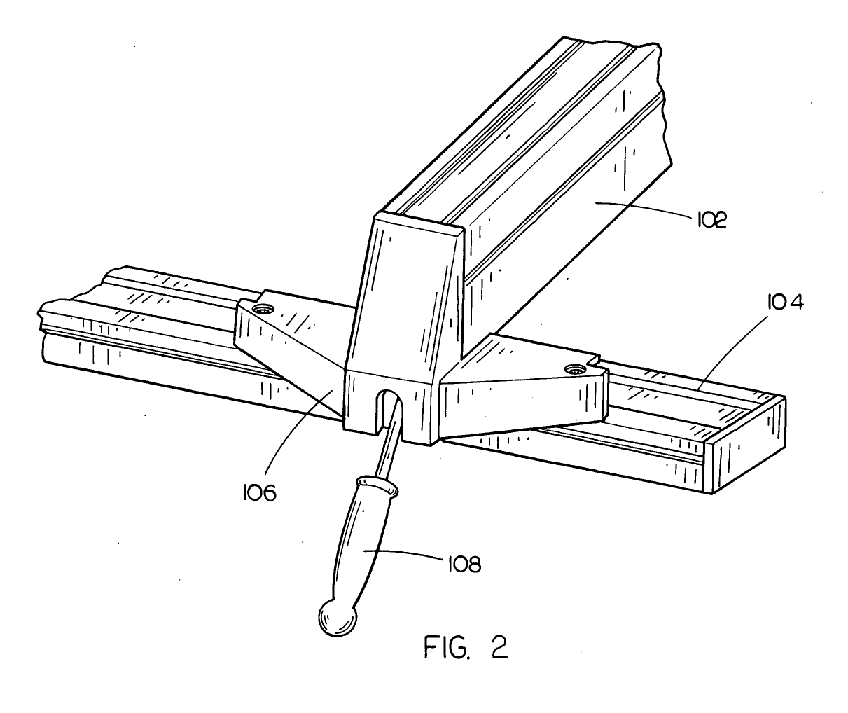

Referring to FIG. 2, an alignment system for a table saw, which includes an alignment fence 102 and a rail 104 is described. The alignment fence 102 is mounted to the rail 104 by a clamping assembly, which includes a partial sleeve 106 for traversing the rail 104 and a cammed clamping mechanism 108 for securing the sleeve 106 to the rail 104. The partial sleeve 106 generally brackets substantially all but the bottom surface of the rail 104. The alignment fence 102 slides along the rail 104 and allows for precise repeatable workpiece positioning. When positioning larger workpieces, the alignment fence 102 travels a longer path and therefore, requires a longer rail 104. Since longer rails 104 may be easily damaged or more expensive to transport, it is advantageous to transport such rails 104 in sections.

Referring generally to FIGS. 1-4, exemplary embodiments of the present invention are described. In a present embodiment, an alignment apparatus, such as a rail 104 for an alignment fence 102 of a table saw 100, is disclosed. The apparatus includes a first wedging member 202, a second wedging member 204, a first rail section 210 and a second rail section 212. Each rail section (210, 212) includes a surface defining one or more apertures for receiving one or more fasteners (206, 208).

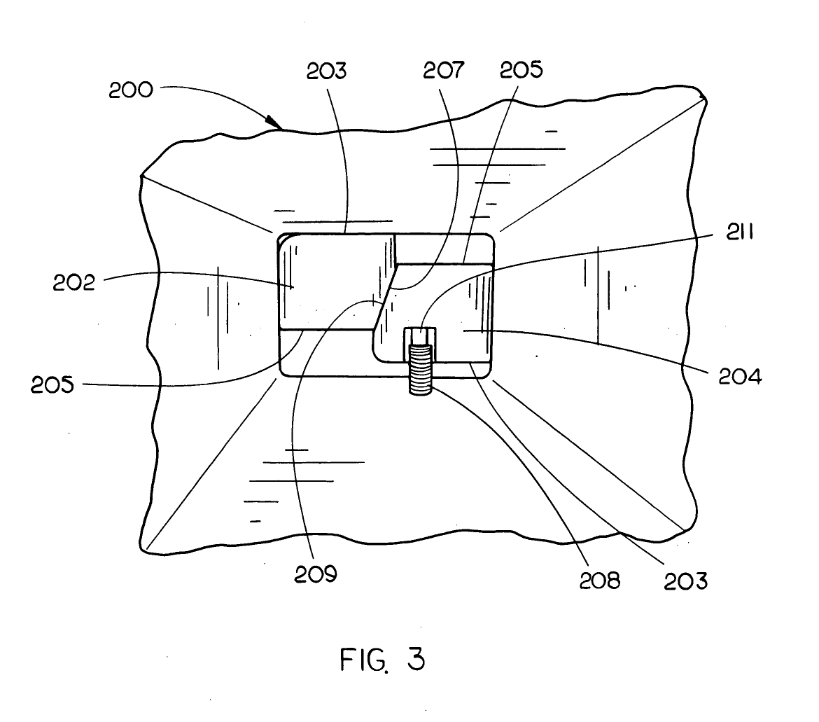

In a current embodiment, the wedging members (202, 204) are generally opposing, rectilinearly-shaped wedging members. Further, the rectilinearly-shaped wedging members (202, 204) are tapered (when viewed longitudinally as in FIG. 3), each having a base portion 203 which tapers to a tip portion 205. Additionally, the first wedging member 202 includes a inclined surface 207, while the second wedging member 204 includes a corresponding inclined surface 209 for engaging with the inclined surface of the first wedging member 202. (as shown in FIG. 3). In further embodiments, it is contemplated that the wedging members 202, 204 of the present invention may be generally opposing wedging members of various shapes, such as semi-circular shaped wedging members for implementation in connecting for example, a cylindrically shaped rail.

In exemplary embodiments, the wedging members (202, 204) are formed of a rigid material, such as steel, to provide sufficient durability for maintaining a stable connection between the rail sections. In alternative embodiments, one or both of the wedging members (202, 204) may be formed of a more commercially available product such as plastic, a composite material, other metals or the like. In additional embodiments, one or both of the wedging members (202, 204) may be formed of a malleable material, such as aluminum or an aluminum alloy for promoting secure engagement between the inclined surfaces of the wedging members (202, 204).

In a present embodiment, the first and second rail sections (210, 212) are rectilinearly shaped. In further embodiments, it is contemplated that the first and second rail sections (210, 212) may be cylindrically-shaped, or various other shapes.

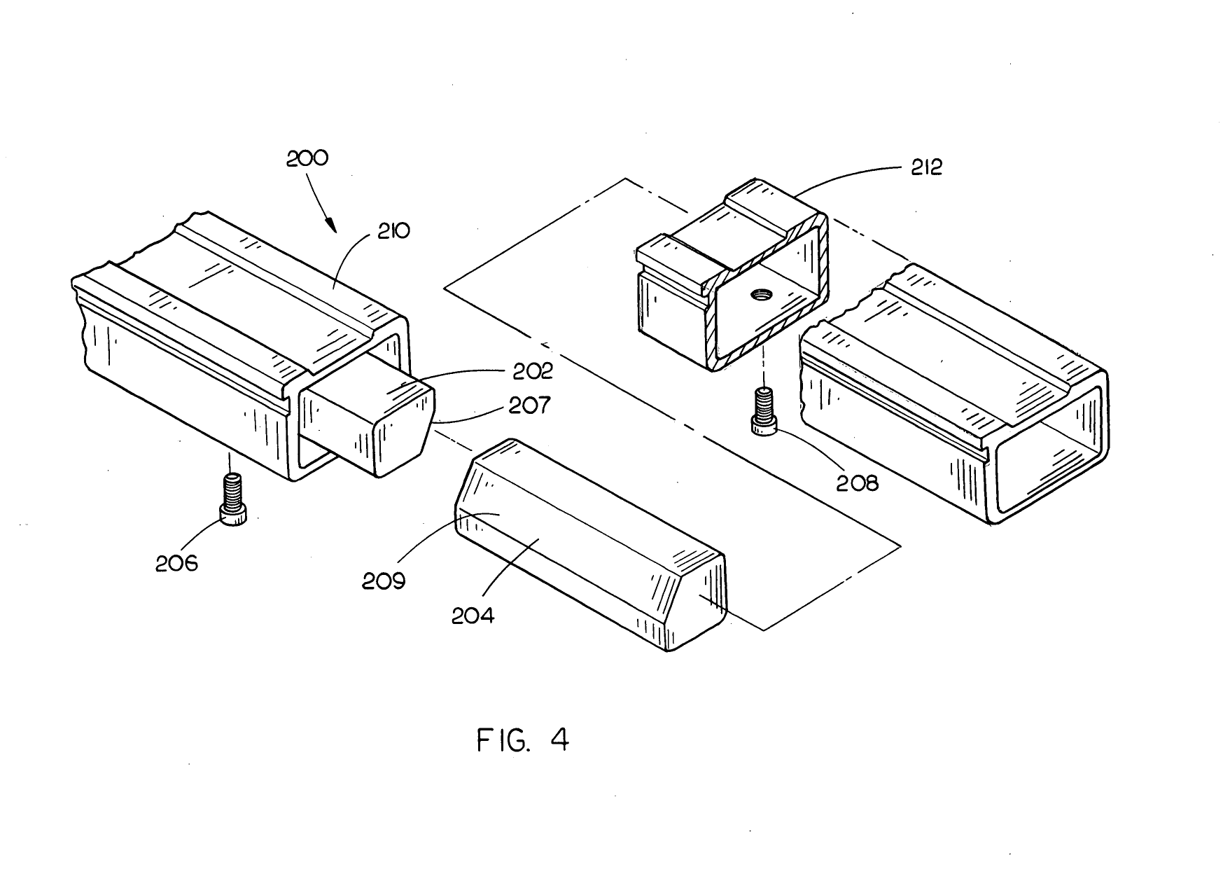

In current embodiments, the first and second rail sections (210, 212) are configured for being connected to one another as part of an alignment apparatus. For example, the first and second rail sections may be positioned so that they connect in an end-to-end fashion. In a present embodiment, the wedging members (202, 204) are positioned within the first and second rail sections (210, 212) as shown in FIGS. 3 and 4. The wedging members (202, 204) are oriented so that a portion of each wedging member is positioned at least partially within both the first and second rail sections (210, 212) on each side of a splice between the first and second rail sections (210, 212). The rail sections (210, 212) are oriented in an end to end configuration. (as shown in FIGS. 3 and 4). In an exemplary embodiment, the rail sections may include markings showing where the wedging members (202, 204) should be positioned. The first wedging member 202 is positioned so that its base portion 205 (when viewed longitudinally as in FIG. 3) is oriented towards the top interior surface of both the first and second rail sections (210, 212). The second wedging member 204 is positioned so that its base portion (when viewed longitudinally as in FIG. 3) is oriented towards the bottom interior surface of both the first and second rail sections (210, 212). Further, the first and second wedging members (202, 204) are positioned so that the inclined surfaces (207, 209) of each of the wedging members are oriented toward one another.

In an exemplary embodiment, as shown in FIGS. 3 and 4, one or more fasteners (206, 208) are directed against the base portion 203 of the second wedging member 204, thereby forcing the inclined surface 209 of the second wedging member 204 to engage with the corresponding inclined surface 207 of the first wedging member 202. The one or more fasteners (206, 208) are introduced via one or more corresponding apertures configured within the first and second rail sections (210, 212). For instance, the apertures may be threaded for receiving a fastener such as a screw, a bolt or the like. Preferably, the fasteners (206, 208) are introduced through the surfaces of the rail sections (210, 212) in such a manner so as to not interfere with the performance of the alignment fence. In a present embodiment, the apertures are configured in the bottom surfaces (when viewed as in FIG. 3) of the rail sections (210, 212), so that fasteners introduced via said apertures will not interfere with an alignment fence moving along the rail 104 formed by the connected rail sections (210, 212). In an exemplary embodiment, a first fastener 206 is introduced via a first aperture configured within the first rail section 210. The first fastener 206 is directed against the base portion 203 of the second wedging member 204. The second fastener 208 is introduced via a second aperture configured within the second rail section 212. The second fastener 208 is also directed against the base portion 203 of the second wedging member 204. The fasteners (206, 208) serve to force the inclined surface 209 of the second wedging member 204 against the inclined surface 207 of the first wedging member 202. (as shown in FIG. 3). The inclined surfaces (207, 209) of the first and second wedging members (202, 204) mechanically engage, and the first and second wedging members (202, 204) further engage with at least a portion of the first and second rail sections (210, 212) so as to connect the first and second rail sections. (210, 212).

In an exemplary embodiment, the base portion 203 of the second wedging member 204 may include one or more notched or recessed portions 211 for receiving one or more fasteners as shown in FIG. 3. For example, the second wedging member 204 may include one or more separately located recessed portions 211 along its base portion 203 or may be configured with a single recessed portion 211 grooved longitudinally (when the second wedging member is oriented as viewed in FIG. 3) along the entire span of the base portion 203. The recessed portion 211 is configured to receive the fastener 208 in such a manner so that the alignment of second wedging member 204 is maintained as it is being forcibly engaged by one or more fasteners towards the first wedging member 202.

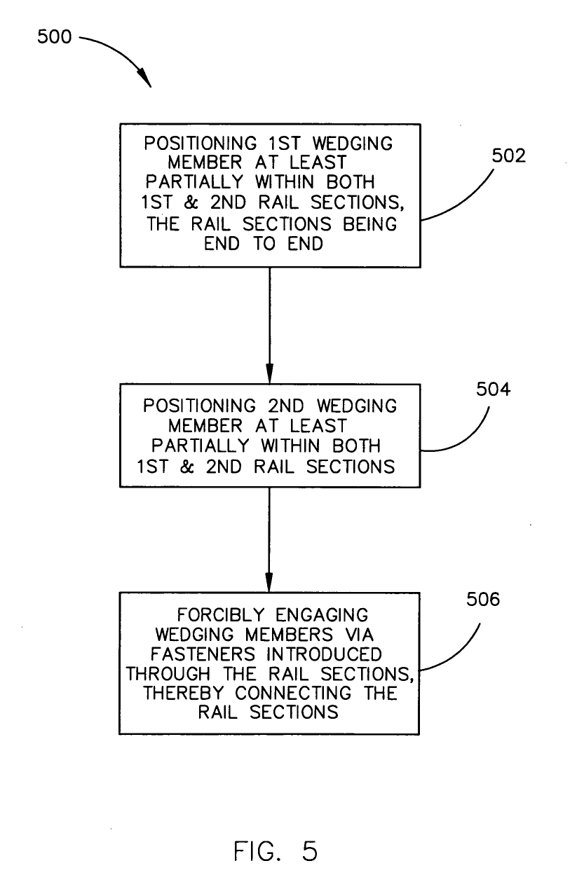

In an additional aspect of the present invention, as shown in FIG. 5, a method 500 for coupling an alignment apparatus, such as a rail for a table saw, includes positioning a first wedging member at least partially within both a first and second rail section, the first and second rail sections being oriented in an end to end configuration 502. The method further includes positioning a second wedging member at least partially within both the first and second rail sections 504. The method further includes forcibly engaging the wedging members, via fasteners introduced through the rail sections, thereby connecting the rail sections 506. An additional step may be implemented, prior to shipping, involving containing the wedging members within the rail sections, which may be achieved by wrapping a deformable plastic over the open end(s) of each rail section. Also, the wedging members may be bundled together using deformable plastic, tape, caulk or the like. A further additional step may be implemented, prior to shipping, involving temporarily securing at least one of the wedging members to the interior surfaces of the rail sections. This step may be achieved by using caulk, tape, glue or the like.

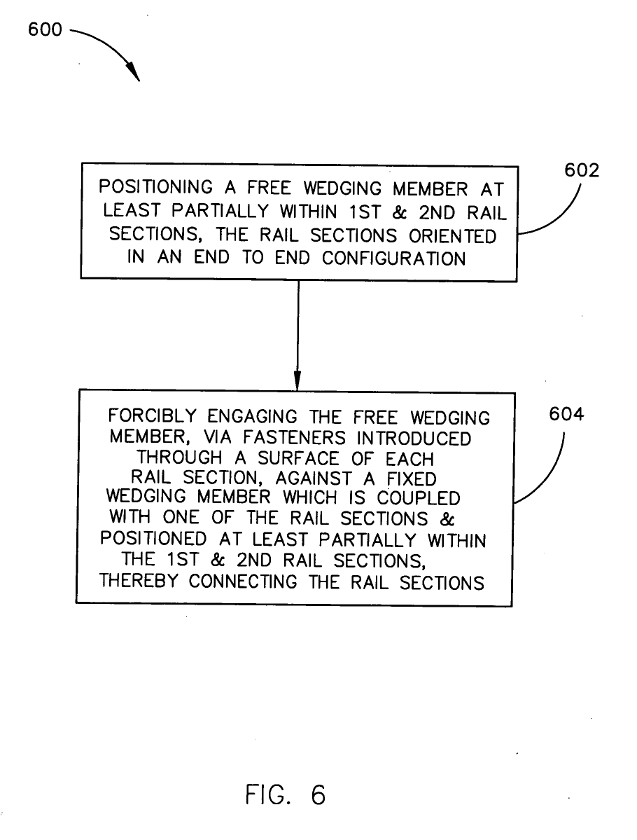

In a further aspect of the present invention, as shown in FIG. 6, a method 600 for coupling an alignment apparatus, such as a rail for a table saw, includes positioning a free wedging member at least partially within first and second rail sections, the rail sections oriented in an end to end configuration 602 and forcibly engaging the free wedging member, via fasteners introduced through the bottom surface of each rail section, against a fixed wedging member, thereby connecting the rail sections 604, the fixed wedging member being positioned at least partially within the first and second rail sections and coupled with the interior surface of one of the rail sections. In present embodiments, the fixed wedging member is coupled with the interior surface of a rail section by glue, caulk or the like. In further embodiments, the fixed wedging member may be coupled with the interior surface of a rail section by one or more mechanical connections, such as tabs, hooks and the like. In additional embodiments, the fixed wedging member may be integrally formed with the interior surface of a rail section.

It is believed that the apparatus and method of the present invention and many of its attendant advantages will be understood by the forgoing description. It is also believed that it will be apparent that various changes may be made in the form, construction and arrangement of the components thereof without departing from the scope and spirit of the invention or without sacrificing all of its material advantages. The form herein before described being merely an explanatory embodiment thereof.

What is claimed is:

1. An alignment apparatus, comprising:
a first wedging member and a second wedging member, the first wedging member and the second wedging member having individually corresponding inclined surfaces; and
a first rail section and a second rail section, the first rail section and the second rail section each having a surface defining at least one aperture configured for receiving a fastener;
wherein the first wedging member and the second wedging member are positionable so that at least a portion of each wedging member is within both the first rail section and the second rail section, the first and second wedging members further being positionable so that the corresponding inclined surfaces of the first wedging member and the second wedging member are forcibly engageable via fasteners introduced through each aperture, the first and second wedging members further engageable with at least a portion of the first and second rail sections so as to connect the rail sections.

2. An alignment apparatus as claimed in claim 1, wherein the first and the second rail sections are rectilinearly shaped.

3. An alignment apparatus as claimed in claim 1, wherein the second wedging member defines at least one recessed portion for receiving at least one fastener, the at least one recessed portion for maintaining the alignment of the second wedging member as it is being forcibly engaged with the first wedging member.

4. An alignment apparatus as claimed in claim 1, wherein the first and the second wedging members are rectilinearly shaped.

5. An alignment apparatus as claimed in claim 1, wherein the first and the second rail sections are oriented to connect in an end to end configuration.

6. An alignment apparatus as claimed in claim 1, wherein the first and the second rail sections are configured for coupling with an alignment fence of a table saw.

7. An alignment apparatus as claimed in claim 1, wherein the portion of the second wedging member that is at least partially within the first rail section is engaged by a first fastener and the portion of the second wedging member that is at least partially within the second rail section is engaged by a second fastener for forcibly engaging the second wedging member with the first wedging member.

8. An alignment apparatus as claimed in claim 1, wherein the first wedging member is fixed within and against one of the rail sections by at least one of a fastener, caulk, a mechanical connection or glue.

9. An alignment apparatus as claimed in claim 1, wherein the second wedging member is removably coupled within and against one of the rail sections by at least one of caulk, tape or glue.

10. A method for coupling an alignment apparatus, comprising the steps of:
positioning a first wedging member at least partially within both a first rail section and a second rail section, the first and second rail sections being oriented in an end to end configuration;
positioning a second wedging member at least partially within both the first rail section and the second rail section; and
forcibly engaging the wedging members, via at least one fastener introduced through the rail sections, thereby connecting the rail sections.

11. A method for coupling an alignment apparatus as claimed in claim 10, wherein the first and the second wedging members are generally opposing, rectilinearly shaped wedging members.

12. A method for coupling an alignment apparatus as claimed in claim 10, wherein the first and the second rail sections are rectilinearly shaped.

13. A method for coupling an alignment apparatus as claimed in claim 10, wherein the first and the second wedging members each have an inclined surface, the inclined surface of the first wedging member configured for correspondingly engaging with the inclined surface of the second wedging member.

14. A method for coupling an alignment apparatus as claimed in claim 10, wherein the first and the second rail sections are configured for coupling an alignment fence of a table saw.

15. A method for coupling an alignment apparatus as claimed in claim 10, wherein the portion of the second wedging member that is at least partially within the first rail section is engaged by a first fastener and the portion of the second wedging member that is at least partially within the second rail section is engaged by a second fastener for forcibly engaging the second wedging member with the first wedging member.

16. A method for coupling an alignment apparatus as claimed in claim 10, wherein the first wedging member is fixed within and against one of the rail sections by at least one of a fastener, caulk, a mechanical connection or glue.

17. A method for coupling an alignment apparatus as claimed in claim 10, wherein the second wedging member is removably coupled within and against one of the rail sections by at least one of caulk, tape or glue.

18. A table saw, comprising:
a rail including a first rail section and a second rail section oriented in an end to end configuration;
an alignment fence slidably coupled with the rail; and
means for connecting the rail sections.

19. A table saw as claimed in claim 18, further comprising a means for securing the rail.

20. A table saw as claimed in claim 18, wherein the means for connecting the rail includes a first wedging member and a second wedging member.
